(19) United States
(12) Patent Application Publication
(10) Pub. No.: US 2025/0252495 A1
(43) Pub. Date: Aug. 7, 2025

(54) METHOD AND SYSTEM FOR MATCHING PUBLIC TECHNOLOGY WITH TECHNOLOGY CONSUMER

(71) Applicant: KOREA INSTITUTE OF SCIENCE & TECHNOLOGY INFORMATION, Daejeon (KR)

(72) Inventors: Min Ju KIM, Seoul (KR); Kuk Jin BAE, Seongnam-si (KR); Ji Min KIM, Yongin-si (KR); Yun Jeong CHOI, Seoul (KR); Jeong Eun BYUN, Seoul (KR); Eun Sun KIM, Seoul (KR); Sung Jin KIM, Seoul (KR); Ju Yeon SHIN, Yongin-si (KR); Min Je CHO, Seoul (KR); Su Min SEO, Seoul (KR)

(73) Assignee: KOREA INSTITUTE OF SCIENCE & TECHNOLOGY INFORMATION, Daejeon (KR)

(21) Appl. No.: 19/045,328

(22) Filed: Feb. 4, 2025

(30) Foreign Application Priority Data
Feb. 5, 2024 (KR) 10-2024-0017108

(51) Int. Cl. G06Q 40/04; G06Q 30/0282

(52) U.S. Cl. CPC G06Q 40/04; G06Q 30/0282

(57) ABSTRACT

There is provided a method for matching a public technology with a technology consumer, the method being performed by a computing system. The method may comprise acquiring data about the public technology, applying the acquired data to a first machine-learning model to acquire technology feature data about the public technology, wherein the first machine-learning model is configured to output the technology feature data based on the data about the public technology and matching the public technology with at least one technology consumer, based on the technology feature data and a plurality of consumer feature data stored in a database.

### CROSS-REFERENCE TO RELATED APPLICATION

This application claims priority from Korean Patent Application No. 10-2024-0017108 filed on Feb. 5, 2024 in the Korean Intellectual Property Office, and all the benefits accruing therefrom under 35 U.S.C. 119, the contents of which in its entirety are herein in company by reference.

### BACKGROUND

### Field

The present disclosure relates to a method and system for matching a public technology with a technology consumer. More specifically, the present disclosure relates to a method and system for matching a public technology with a technology consumer so as to increase success possibility of the technology trade.

### Description of Related Art

There are platforms for technology trade between a public technology and a technology consumer. The technology trade and technology transfer are taking place on these platforms. However, public R&D research productivity and technology commercialization success percentage are low compared to the government's R&D investment amount. It is difficult to connect the public technology to the technology consumer using the platforms.

One of the main reasons for the difficulty in connecting the public technology and the technology consumer with each other may be the gap in information between the public technology and the technology consumer. Conventional trade platforms between the public technology and the technology consumer provide only information focused on the public technology or operate in a relying manner on expert's technology search for matching the public technology with a technology consumer, thereby causing limitations from the perspective of the technology consumer.

Therefore, a method for matching the public technology with a technology consumer that may increase the success possibility of the technology trade is required.

### SUMMARY

A technical purpose to be achieved in accordance with some embodiments of the present disclosure is to provide a method and system for improving a success possibility of a technology trade between a public technology and a technology consumer by using a machine-learning model.

A technical purpose to be achieved in accordance with some embodiments of the present disclosure is to provide a method and system for improving a matching speed in matching a public technology with a technology consumer.

A technical purpose to be achieved in accordance with some embodiments of the present disclosure is to provide a method and system for lightening a machine-learning model used for matching a public technology with a technology consumer.

The technical purposes of the present disclosure are not limited to the technical purposes as mentioned above, and other technical purposes as not mentioned may be clearly understood by those skilled in the art from descriptions as set forth below.

According to an aspect of the present disclosure, there is provided a method for matching a public technology with a technology consumer, the method being performed by a computing system. The method may comprise acquiring data about the public technology, applying the acquired data to a first machine-learning model to acquire technology feature data about the public technology, wherein the first machine-learning model is configured to output the technology feature data based on the data about the public technology and matching the public technology with at least one technology consumer, based on the technology feature data and a plurality of consumer feature data stored in a database.

In some embodiments, the method may further comprise before the acquiring of the data about the public technology, acquiring a plurality of data respectively about a plurality of technology consumers, applying the plurality of data respectively about the plurality of technology consumers to a second machine-learning model to acquire a plurality of consumer feature data respectively about the plurality of technology consumers, wherein the second machine-learning model may be configured to output the consumer feature data based on the data about the technology consumer and storing the acquired plurality of consumer feature data in the database.

In some embodiments, the matching of the public technology with the at least one technology consumer may include applying the technology feature data and the plurality of consumer feature data to a third machine-learning model to acquire a score indicating a technology trade success possibility corresponding to each of the plurality of consumer feature data, wherein the third machine-learning model is configured to output the score indicating the success possibility of the technology trade between the technology feature data and the consumer feature data, extracting one or more consumer feature data from the plurality of consumer feature data based on the acquired score and determining at least one technology consumer matching the public technology, based on the extracted one or more consumer feature data.

In some embodiments, the extracting of the one or more consumer feature data from the plurality of consumer feature data may include extracting one or more consumer feature data corresponding to a score included in a predetermined rank among scores corresponding to the plurality of consumer feature data.

In some embodiments, the extracting of the one or more consumer feature data from the plurality of consumer feature data may include extracting one or more consumer feature data corresponding to a score higher than or equal to a predetermined threshold value among scores corresponding to the plurality of consumer feature data.

In some embodiments, the matching of the public technology with the at least one technology consumer may include converting the acquired score into a normalized value within a predetermined range, wherein the matching method may further comprise, after the matching of the public technology with the at least one technology consumer, transmitting information about the at least one technology consumer to a user device, the information about the technology consumer may include the normalized value.

According to an aspect of the present disclosure, there is provided a method for matching a public technology with a technology consumer, the method being performed by a computing system. The method may comprise acquiring data about the technology consumer, applying the acquired data to a first machine-learning model to acquire consumer feature data about the technology consumer, wherein the first machine-learning model is configured to output the consumer feature data based on the data about the technology consumer and matching the technology consumer with one or more public technologies, based on the consumer feature data and a plurality of technology feature data stored in a database.

According to an aspect of the present disclosure, there is provided a method for constructing a database for matching a public technology with a technology consumer, the method being performed by a computing system. The method may comprise acquiring data about the public technology, applying the data about the public technology to a first machine-learning model to acquire technology feature data about the public technology, wherein the first machine-learning model is configured to output the technology feature data based on the data about the public technology and associating the technology feature data with a public technology identifier, and storing the association in a database.

In some embodiments, the first machine-learning model may include a preprocessing unit, wherein the data about the public technology may include at least one text. The preprocessing unit may be configured to: extract at least one keyword from the at least one text, reduce a first magnitude vector based on the extracted at least one keyword into a second magnitude vector, wherein the second magnitude is smaller than the first magnitude and output the second magnitude vector.

In some embodiments, the method for matching may further comprise acquiring data about the technology consumer, applying the data about the technology consumer to a second machine-learning model to acquire consumer feature data about the technology consumer, wherein the second machine-learning model is configured to output the consumer feature data based on the data about the technology consumer and associating the consumer feature data with a technology consumer identifier and storing the association in the database.

In some embodiments, the second machine-learning model may include a preprocessing unit, wherein the data about the public technology may includes at least one text. The preprocessing unit is configured to: extract at least one keyword from the at least one text; reduce a third magnitude vector based on the extracted at least one keyword into a fourth magnitude vector, wherein the fourth magnitude smaller than the third magnitude; and output the fourth magnitude vector.

### BRIEF DESCRIPTION OF DRAWINGS

The above and other aspects and features of the present disclosure will become more apparent by describing in detail illustrative embodiments thereof with reference to the attached drawings, in which:

FIG. 1 is a configuration diagram of a system for matching a public technology with a technology consumer according to one embodiment of the present disclosure;

FIG. 2 is a flowchart for illustrating a method for acquiring technology feature data and consumer feature data according to one embodiment of the present disclosure;

FIG. 3 is a diagram illustrating first raw data;

FIG. 4 is a diagram illustrating second raw data;

FIG. 5 is a diagram illustrating examples of the public technology data and technology consumer data;

FIG. 6 is a diagram illustrating a configuration of a first machine-learning model according to one embodiment of the present disclosure;

FIG. 7 is a diagram illustrating a configuration of a second machine-learning model according to one embodiment of the present disclosure;

FIG. 8 is a diagram illustrating a configuration of a third machine-learning model according to one embodiment of the present disclosure;

FIG. 9 is a diagram illustrating an artificial neural network model according to one embodiment of the present disclosure;

FIG. 10 is a flowchart for illustrating a method for matching a public technology with a technology consumer according to one embodiment of the present disclosure;

FIG. 11 is a diagram illustrating a procedure for calculating a score indicating a success possibility of a technology trade using the first machine-learning model and the third machine-learning model according to an embodiment of the present disclosure.

FIG. 12 is a flowchart for illustrating a method for matching a public technology with a technology consumer according to another embodiment of the present disclosure;

FIG. 13 is a diagram illustrating a procedure for calculating a score indicating a technology trade success possibility using the second machine-learning model and the third machine-learning model according to one embodiment of the present disclosure; and

FIG. 14 is a hardware configuration diagram of a computing system according to some embodiments of the present disclosure.

### DETAILED DESCRIPTIONS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Before describing embodiments of the present disclosure, the terms used in the present disclosure will be defined.

In embodiments of the present disclosure, the term “public technology” as used herein may be a technology owned by a public institution. For example, the public technology may include a technology related to R&D technology project, a technology related to R&D commercialization project, etc. at the public institution.

In embodiments of the present disclosure, the term “technology consumer” as used herein may include an organization, an individual, or a company that wishes to use the public technology. For example, the technology consumer may include companies, individuals, organizations, schools, etc. Hereinafter, some embodiments of the present disclosure are described in detail according to the attached drawings.

Hereinafter, embodiments of the present disclosure will be described with reference to the attached drawings.

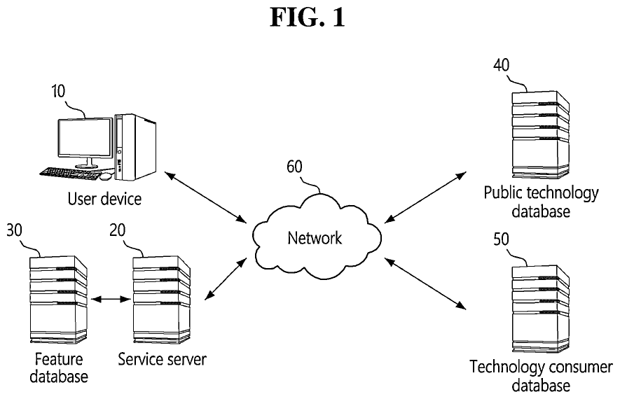

FIG. 1 is a configuration diagram of a system for matching a public technology with a technology consumer according to an embodiment of the present disclosure.

Referring to FIG. 1, the matching system according to an embodiment of the present disclosure may include a user device 10, a service server 20, a feature database 30 (hereinafter, referred to as a ‘feature DB’), a public technology database 40 (hereinafter, referred to as a ‘public technology DB’), and a technology consumer database 50 (hereinafter, referred to as a ‘technology consumer DB’). Each of the service server 20, the user device 10, the public technology DB 40, and the technology consumer DB 50 may communicate with each other through a network 60. In this regard, the network 60 may include a wired Internet network, a mobile communication network, etc.

According to one embodiment, the public technology DB 40 may store therein a plurality of first raw data about various public technologies held by a public institution. For example, the public technology DB 40 may store therein public R&D technology project data, public R&D commercialization project data, etc. as held by a public institution as the plurality of first raw data. Data profiling may be performed based on the first raw data, such that data about the public technology (hereinafter, referred to as ‘public technology data’) is extracted. Then, the ‘public technology data’ may be applied to a first machine-learning model.

The technology consumer DB 50 may store therein a plurality of second raw data about the technology consumer who wishes to use the public technology. For example, the technology consumer DB 40 may store therein a plurality of second raw data such as technology trade company data, technology commercialization company data, etc. Data profiling may be performed based on the second raw data such that data about the technology consumer (hereinafter, referred to as ‘technology consumer data’) is extracted, which in turn may be applied to a second machine-learning model.

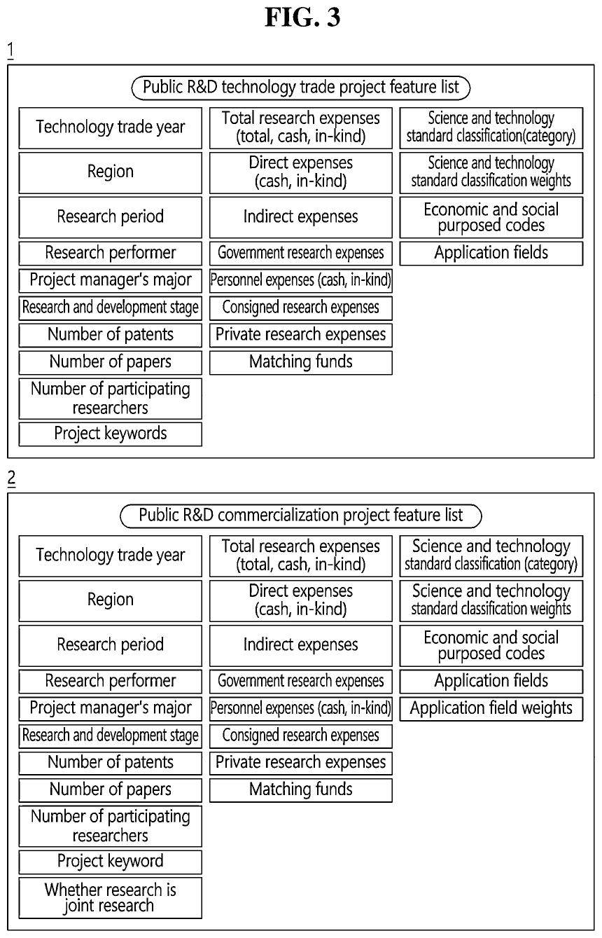

Examples of the first raw data, the second raw data, the public technology data, and the technology consumer data will be described later with reference to FIGS. 3 to 5.

According to one embodiment, the first machine-learning model may be used to extract a plurality of technology feature data from a plurality of public technology data. In this regard, the technology feature data may be a multidimensional vector representing a feature of the public technology. Furthermore, the second machine-learning model may be used to extract a plurality of consumer feature data from a plurality of technology consumers data. In this regard, the consumer feature data may be a multidimensional vector representing a feature of the technology consumer.

According to one embodiment, the service server 20 may apply the plurality of public technology data to the first machine-learning model to acquire a plurality of technology feature data from the first machine-learning model, and may store the plurality of technology feature data in the feature DB 30. The service server 20 may associate a public technology identifier (e.g., technology name, technology ID, etc.) with the technology feature data and store the association in the feature DB 30. In this regard, the first machine-learning model may be a model trained to perform an inference operation based on the public technology data and output the technology feature data about the public technology.

Furthermore, the service server 20 may apply the plurality of technology consumers data to the second machine-learning model to acquire a plurality of consumer feature data from the second machine-learning model, and store the plurality of consumer feature data in the feature DB 30. The service server 20 may associate the identifier of the technology consumer with the consumer feature data and store the association into the feature DB 30. In this regard, the technology consumer identifier may be a login ID, an organization name, a company name, a university name, etc. of the technology consumer. In this regard, the second machine-learning model may be a model trained to perform an inference operation based on the technology consumer data and output the technology feature data about the technology consumer.

According to one embodiment, when the service server 20 receives the technology consumer data from the user device 10, the service server may generate a public technology list of public technologies with a high success possibility of the technology trade and transmit matching information including the public technology list to the user device 10. Specifically, the service server 20 may apply the technology consumer data received from the user device 10 to the second machine-learning model to acquire the consumer feature data from the second machine-learning model. Furthermore, the service server 20 may apply the consumer feature data and the plurality of technology feature data stored in the feature DB 30 to a third machine-learning model, and extract one or more technology feature data matching the consumer feature data based on a plurality of scores acquired from the third machine-learning model. In addition, the service server 20 may generate a public technology list based on the extracted one or more technology feature data and transmit matching information including the generated public technology list to the user device 10.

Furthermore, when the service server 20 receives the public technology data from the user device 10, the service server may generate a technology consumer list of public technologies with a high success possibility of the technology trade and transmit matching information including the technology consumer list to the user device 10. Specifically, the service server 20 may apply the public technology data received from the user device 10 to the first machine-learning model, and acquire the technology feature data from the first machine-learning model. Furthermore, the service server 20 may apply the acquired technology feature data and the plurality of technology feature data stored in the feature DB 30 to the third machine-learning model, and extract one or more consumer feature data matching the public technology data based on a plurality of scores acquired from the third machine-learning model. In addition, the service server 20 may generate a consumer technology list based on the extracted one or more consumer feature data and transmit matching information including the generated consumer technology list to the user device 10.

The user device 10 may receive the matching information including the technology consumer list of the technology consumers with a high success possibility of the technology trade or the public technology list of the public technologies with a high success possibility of the technology trade from the service server 20. For example, when the user is a technology supplier, the user device 10 may transmit the public technology data held by the technology supplier to the service server 20 and receive matching information including a technology consumer list from the service server 20. The technology consumer list may include at least one technology consumer identifier and a trade-success possibility prediction value as a numerical value of the success possibility of the technology trade thereof. The trade-success possibility prediction value may be a normalized value within a predetermined range based on a score output from the third machine-learning model.

In another example, when the user is a technology consumer, the user device 10 may transmit the technology consumer data about the technology consumer to the service server 20 and receive the public technology list from the service server 20. The public technology list may include at least one public technology identifier and a trade-success possibility prediction value as a numerical value of the success possibility of the technology trade thereof.

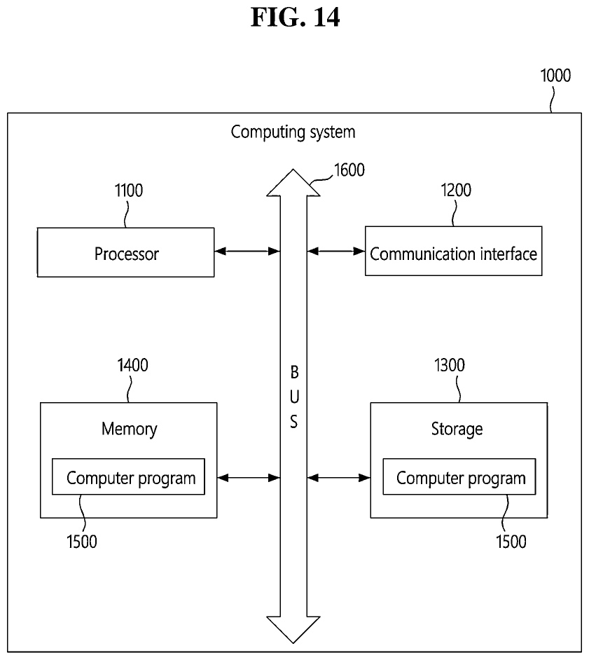

The above-described matching system may be implemented with one or more computing devices having a processor. For example, each component such as the service server 20 may be implemented with one computing device, or the matching system may be implemented with one computing device. The computing device may include any device having a computing function, and an example of such a device is shown in FIG. 14. Since the computing device is a collection of various components (e.g. memory, processor, etc.) interacting with each other, the computing device may be called a ‘computing system’ in some cases. Furthermore, the computing system may mean a collection of a plurality of computing devices interacting with each other.

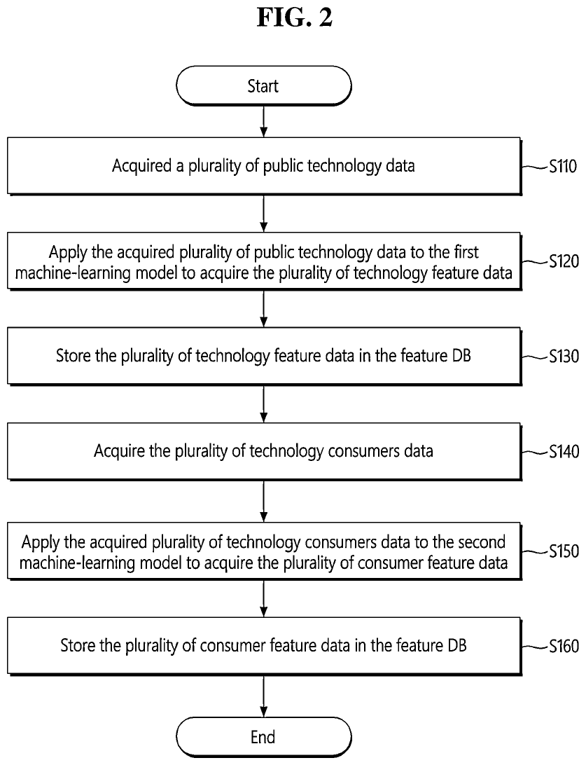

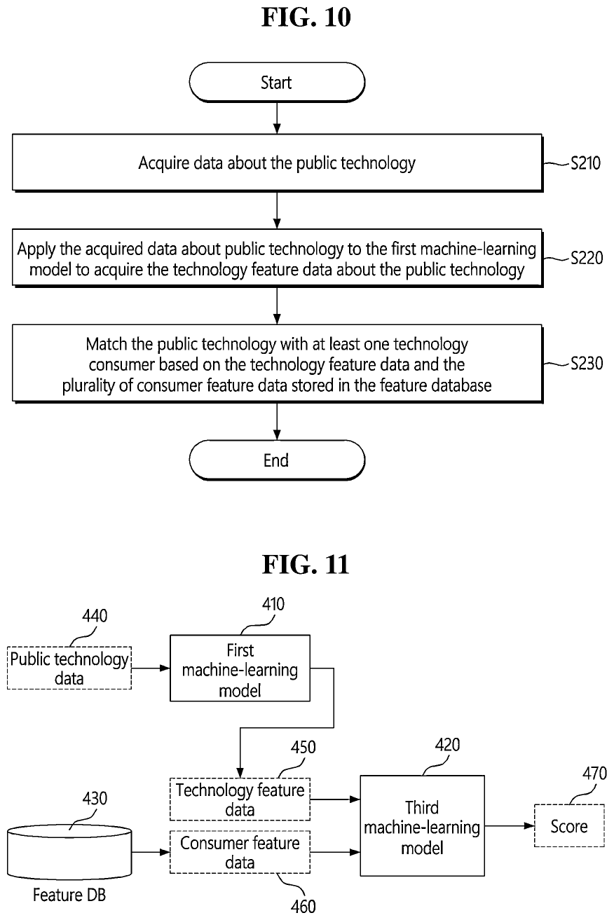

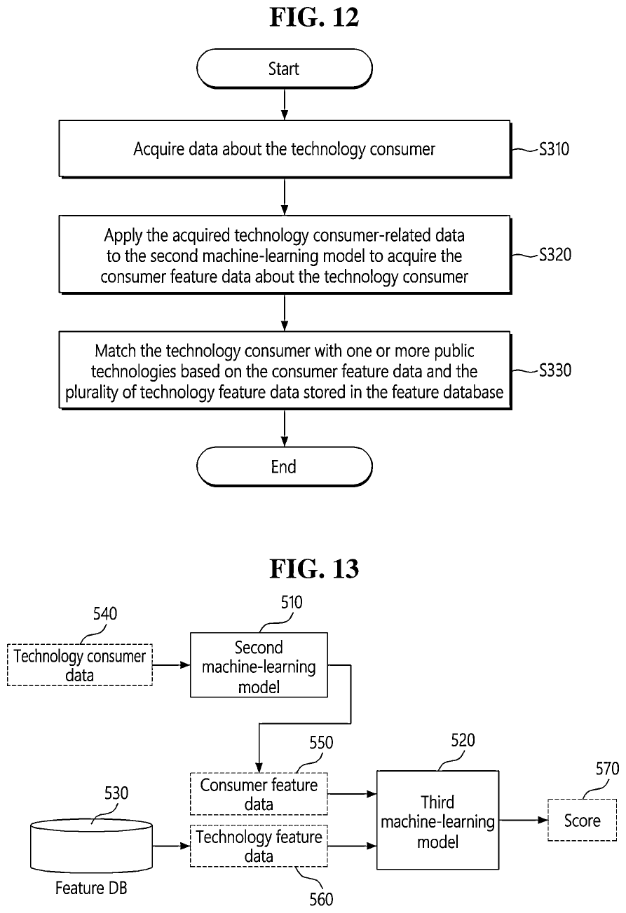

A method for pre-extracting and storing the consumer feature data and the technology feature data according to an embodiment of the present disclosure will be described with reference to FIGS. 2 to 7. Furthermore, a method for matching the public technology with the technology consumer will be described with reference to FIGS. 10 to 13. The method according to the present embodiments may be performed by one or more computing devices. The method as illustrated in FIG. 2, FIG. 10, and FIG. 12 is only one embodiment for achieving the project of the present disclosure, and some operations may be added or deleted as needed. For convenience of descriptions, the method as illustrated in FIG. 2, FIG. 10, and FIG. 12 are described under assumption that the method is performed through the service server illustrated in FIG. 1.

FIG. 2 is a flowchart for illustrating a method for acquiring technology feature data and consumer feature data according to an embodiment of the present disclosure.

The service server may acquire the plurality of public technology data in S110.

For example, the service server may receive the plurality of first raw data respectively about the plurality of public technologies from the public technology DB, and may profile the received plurality of first raw data to acquire the plurality of public technology data. An example of the first raw data about the public technology is illustrated in FIG. 3.

Next, the service server may apply the acquired plurality of public technology data to the first machine-learning model to acquire the plurality of technology feature data in S120. In an embodiment of the present disclosure, applying data to the machine-learning model may be understood as that the machine-learning model performs an inference operation based on the data applied thereto to output result data (e.g., feature data).

Thereafter, the service server may store the plurality of technology feature data in the feature DB in S130. In this regard, the service server may associate the identifier of the public technology with the technology feature data and store the association in the feature DB.

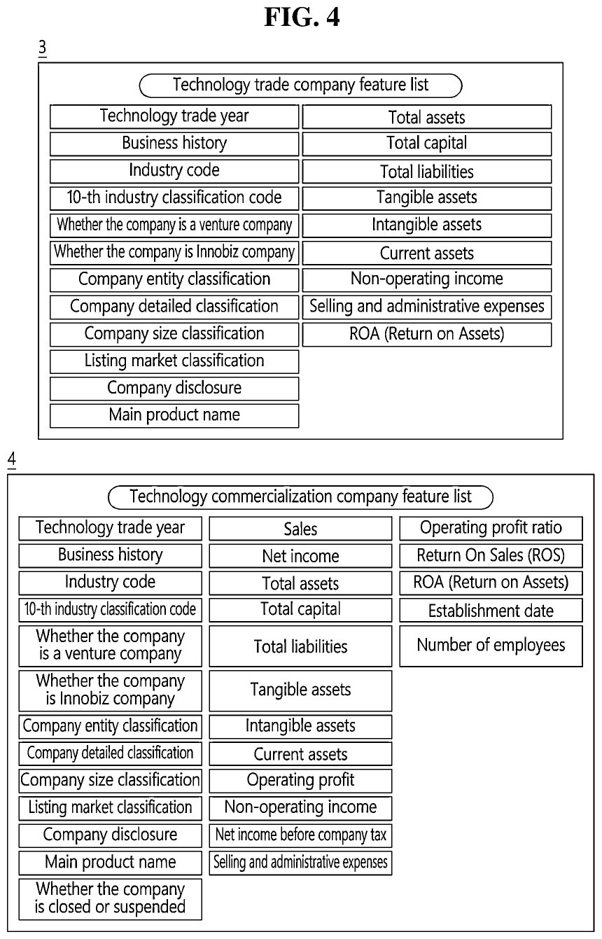

Furthermore, the service server may acquire the plurality of technology consumers data in S140. For example, the service server receives the plurality of second raw data respectively about the plurality of technology consumers from the technology consumer DB, and may profile the received plurality of second raw data to acquire the plurality of technology consumers data. An example of the second raw data about the technology consumer is illustrated in FIG. 4.

Subsequently, the service server may apply the acquired plurality of technology consumers data to the second machine-learning model to acquire the plurality of consumer feature data in S150. Thereafter, the service server may store the plurality of consumer feature data in the feature DB in S160. In this regard, the service server may associate the identifier of the technology consumer with the consumer feature data and store the association in the feature DB.

Hereinafter, examples of the first raw data, the second raw data, the public technology data, and the technology consumer data are described with reference to FIGS. 3 to 5.

FIG. 3 is a diagram illustrating the first raw data.

Referring to FIG. 3, the first raw data may include a public R&D technology trade project feature list 1 and a public R&D commercialization project feature list 2.

According to one embodiment, the public R&D technology trade project feature list 1 for extracting the feature of the public technology may include data/values related to technology trade year, region, research period, research performer, project manager's major, research and development stage, number of patents, number of papers, number of participating researchers, project keywords, total research expenses (total, cash, in-kind), direct expenses (cash, in-kind), indirect expenses, government research expenses, personnel expenses (cash, in-kind), consigned research expenses, private research expenses, matching funds, science and technology standard classification (category), science and technology standard classification weights, economic and social purposed codes, and application fields.

According to one embodiment, the public R&D commercialization project feature list 2 for extracting features of the public technology may include data/values related to technology trade year, region, research period, research performer, project manager's major, research and development stage, number of patents, number of papers, number of participating researchers, project keyword, whether the research is joint research, total research expenses (total, cash, in-kind), direct expenses (cash, in-kind), indirect expenses, government research expenses, personnel expenses (cash, in-kind), consigned research expenses, private research expenses, matching funds, science and technology standard classification (category), science and technology standard classification weights, economic and social purposed codes, application fields, and application field weights.

According to one embodiment, the data profiling may be performed based on the public R&D technology trade project feature list 1 and the public R&D commercialization project feature list 2, so that the public technology data may be acquired. For example, the data profiling may be performed using a data profiling algorithm.

FIG. 4 is a diagram illustrating the second raw data.

Referring to FIG. 4, the second raw data may include a technology trade company feature list 3 and a technology commercialization company feature list 4 as examples of the data about the technology consumer.

According to one embodiment, the technology trade company feature list 3 for extracting features of the technology consumer may include data/values related to technology trade year, business history, industry code, 10-th industry classification code, whether the company is a venture company, whether the company is Innobiz company, company entity classification, company detailed classification, company magnitude classification, listing market classification, company disclosure, main product name, total assets, total capital, total liabilities, tangible assets, intangible assets, current assets, non-operating income, selling and administrative expenses, and ROA (Return on Assets).

According to one embodiment, the technology commercialization company feature list 4 for extracting technology consumer features may include data/values related to technology trade year, business history, industry code, 10-th industry classification code, whether the company is a venture company, whether the company is Innobiz company, company entity classification, company detailed classification, company magnitude classification, listing market classification, company disclosure, main product name, whether the company is closed or suspended, sales, net income, total assets, total capital, total liabilities, tangible assets, intangible assets, current assets, operating profit, non-operating income, net income before company tax, selling and administrative expenses, operating profit ratio, Return On Sales (ROS), ROA (Return on Assets), establishment date, and number of employees.

According to one embodiment, the data profiling may be performed based on the technology trade company feature list 3 and the technology commercialization company feature list 4 to acquire the technology consumer data. For example, the data profiling may be performed based on an algorithm for data profiling.

Data or values other than the data/values exemplified in FIG. 3 and FIG. 4 may be further included in at least one of the public R&D technology trade project feature list 1, the public R&D commercialization project feature list 2, the technology trade company feature list 3, and the technology commercialization company feature list 4.

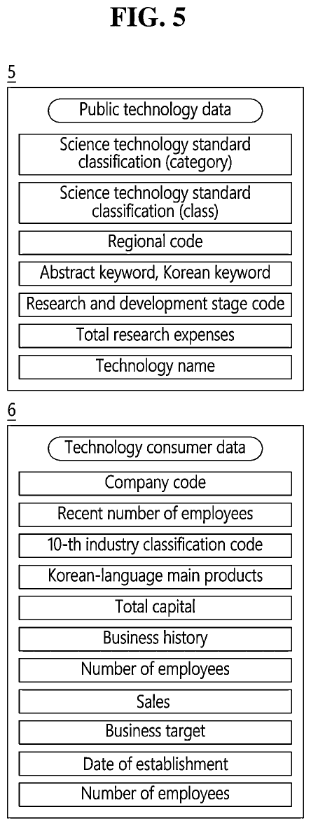

FIG. 5 is a diagram showing examples of the public technology data and the technology consumer data.

Referring to FIG. 5, the public technology data 5 may include data values related to the science technology standard classification (category), science technology standard classification (class), regional code, abstract keyword, and/or Korean keyword, research and development stage code, total research expenses, and technology name. In this regard, the key abstract keyword and/or Korean keyword may be text including a plurality of words, or text including one or more sentences. Furthermore, the science and technology standard classification (category) refers to data for defining the category of the technology. The science and technology standard classification (class) refers to data for defining the class of the technology. The category may include at least one class.

Furthermore, the technology consumer data 6 may include company code, recent number of employees, 10-th industry classification code, Korean-language main products, total capital, business history, number of employees, sales and business target, date of establishment, number of employees, etc. The Korean-language main products may be texts including a plurality of words, or texts including one or more sentences.

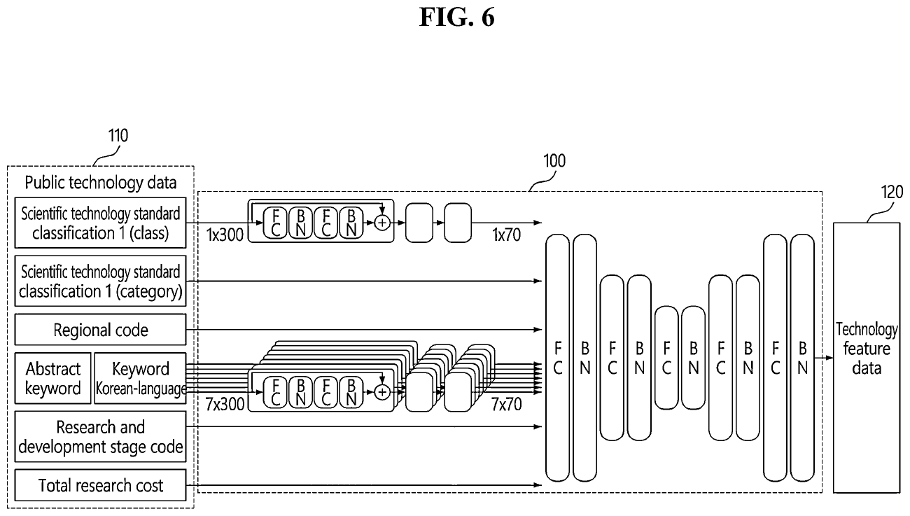

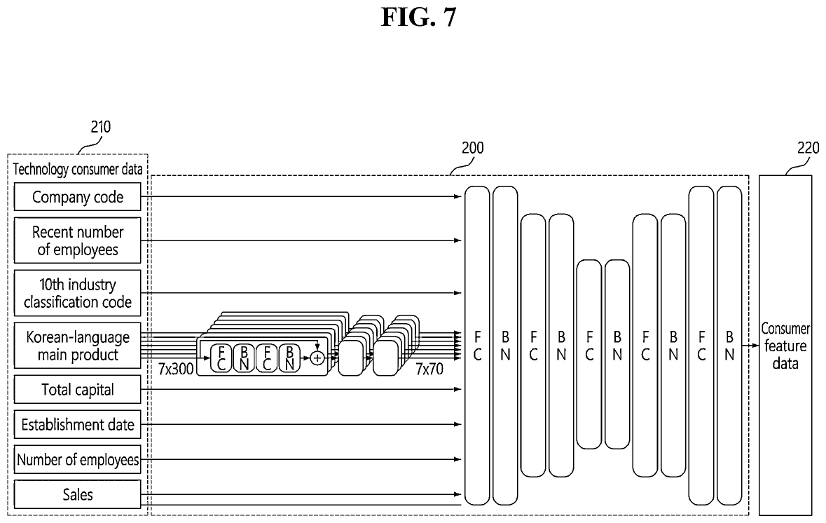

Hereinafter, the first machine-learning model and the second machine-learning model will be described with reference to FIG. 6 and FIG. 7.

FIG. 6 is a diagram illustrating a configuration of the first machine-learning model according to an embodiment of the present disclosure.

Referring to FIG. 6, the public technology data 110 is applied to the first machine-learning model 100 as input data thereto, such that the technology feature data 120 may be output from the first machine-learning model 100. In FIG. 6, an example in which the public technology data 110 includes the scientific technology standard classification 1 (class), the scientific technology standard classification 1 (category), the regional code, the abstract keyword, the research and development stage code, and the total research cost is shown. Those in the public technology data 110 are merely examples. When more efficient input data exists for determination of technology trade success possibility, those in the public technology data 110 may be replaced with the more efficient input data.

According to one embodiment, the first machine-learning model 100 may include a preprocessing unit at a front end thereof, and an auto-encoder at a rear end thereof. For example, the preprocessing unit included in the first machine-learning model 100 may be configured to receive a first magnitude (e.g., 300 magnitude) vector based on 7 keywords extracted from the text related to the abstract keyword and/or Korean keyword, and to reduce the magnitude thereof to a second magnitude (e.g., 70 magnitude) smaller than the first magnitude and to output a vector of the second magnitude. In another example, the preprocessing unit included in the first machine-learning model 100 may be configured to receive a first magnitude (e.g., 300 magnitude) vector based on one keyword extracted from the text related to the science and technology standard classification 1 (class) and to reduce the magnitude thereof to a second magnitude (e.g., 70 magnitude) smaller than the first magnitude and to output a vector of the second magnitude. In this regard, the types and numbers of keywords as used are not limited to the above examples. The keywords may be extracted from various public technology data or the technology consumer data such that the types and numbers of keywords may be changed. By using 7 keywords, the model may utilize sufficient words as an input thereto. The keywords may be input in a form of 7*300 vector, such that the model may utilize sufficient vectorized values. In addition, the model may reduce an output magnitude to 7*70 to improve the efficiency of training. In the auto-encoder at the rear end of the first machine-learning model, the Fully Connected Layer (FC) may perform a process of flattening a tensor trained in a previous layer into a 1*N vector form. The Batch Normalization (BN) may reduce a deviation caused by the difference in the scale of the input variables, thereby preventing influence of a specific input variable from becoming very large or small, thereby increasing the accuracy of the final prediction result.

FIG. 7 is a diagram illustrating a configuration of the second machine-learning model according to an embodiment of the present disclosure.

Referring to FIG. 7, the technology consumer data 210 may be applied to the second machine-learning model 200 such that the consumer feature data 220 may be output from the second machine-learning model 200. In FIG. 7, an example in which the technology consumer data 210 includes the company code, the recent number of employees, 10th industry classification code, Korean-language main product, the total capital, the establishment date, the number of employees, and the sales is shown. However, the those in the technology consumer data 210 here are merely examples. When more efficient input data exists for determination of technology trade success possibility, those in the technology consumer data 210 may be replaced with the more efficient input data.

According to one embodiment, the second machine-learning model 200 may include a preprocessing unit at a front end thereof and an auto-encoder at a back end thereof. For example, the preprocessing unit included in the second machine-learning model 200 may be configured to receive a third magnitude (e.g., 300 magnitude) vector based on seven keywords extracted from text related to the Korean-language main product, and to reduce the magnitude thereof to a fourth magnitude (e.g., 70 magnitude) smaller than the third magnitude and to output a vector of the fourth magnitude. In this regard, the types and numbers of keywords as used are not limited to the above examples. The keywords may be extracted from various public technology data or the technology consumer data such that the types and numbers of keywords may be changed. By using 7 keywords, the model may utilize sufficient words as an input thereto. The keywords may be input in a form of 7*300 vector, such that the model may utilize sufficient vectorized values. In addition, the model may reduce an output magnitude to 7*70 to improve the efficiency of training.

The auto-encoder at the rear end of the second machine-learning model 200 may receive the company code, the recent number of recent employees, the 10th industry classification code, and the value vectorized based on the Korean-language main product, the total capital, the establishment date, the number of employees, and the sales. In the auto-encoder at the rear end of the second machine-learning model 200, the Fully Connected Layer (FC) may perform a process of flattening a tensor trained in a previous layer into a 1*N vector form. The Batch Normalization (BN) may reduce a deviation caused by the difference in the scale of the input variables, thereby preventing influence of a specific input variable from becoming very large or small, thereby increasing the accuracy of the final prediction result.

As described above, the text including a plurality of words or one or more sentences may be preprocessed so that the resulting vector is reduced and then input to the auto-encoder. Accordingly, a computation speed of each of the first machine-learning model 100 and the second machine-learning model 200 may be improved, and each of the first machine-learning model 100 and the second machine-learning model 200 may be lighter.

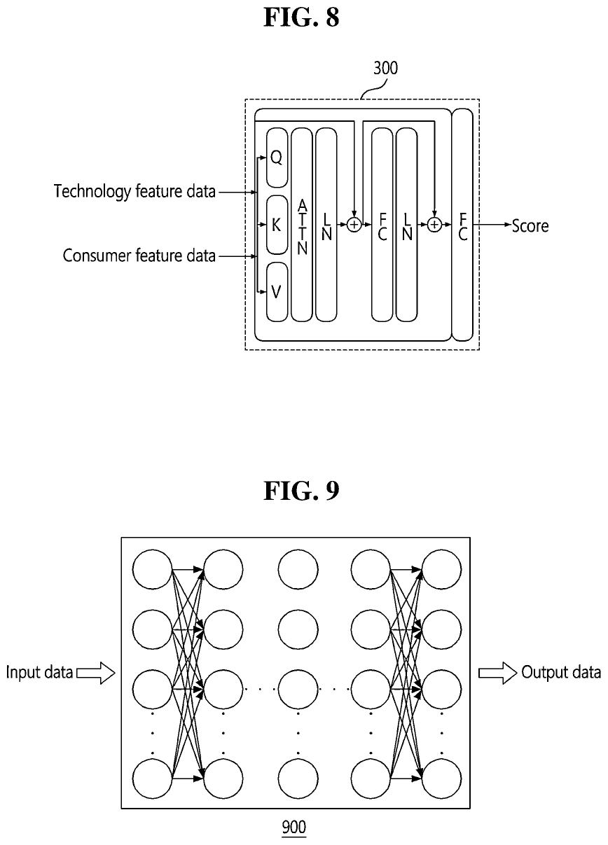

FIG. 8 is a diagram illustrating a configuration of the third machine-learning model according to an embodiment of the present disclosure.

Referring to FIG. 8, the technology feature data and the consumer feature data may be input to the third machine-learning model 300, such that a score indicating the success possibility of the technology trade may be output from the third machine-learning model 300.

The technology feature data and the consumer feature data may be combined into a combination which may be input to the third machine-learning model 300. For example, the combination of the technology feature data and the consumer feature data may be converted into at least one of Q vector, K vector, and V vector. Then, the third machine-learning model 300 may perform a dot product on each of the converted Q vector and K vector to produce a score corresponding to the combination of the technology feature data and the consumer feature data. Thereafter, the third machine-learning model 300 may add the V vector to the score in a weighted manner such that the score corresponding to the combination of the technology feature data and the consumer feature data may be output from the third machine-learning model 300.

As illustrated in FIG. 8, the third machine-learning model 300 may be configured to include an attention module ATTN, a fully connected layer FC, and a layer normalization LN. The attention module may to perform inference based on predetermined one or more vectors among the Q vector, the K vector, and the V vector.

Furthermore, Fully Connected Layer FC may perform a process of flattening the tensor trained in the previous layer in a 1*N vector form. Furthermore, Layer Normalization LN may perform data normalization based on the average and the standard deviation.

According to one embodiment, a plurality of scores output from the third machine-learning model 300 may be respectively converted into a plurality of percentage values. Furthermore, the converted plurality of percentage values may be normalized and converted into normalized values within a predetermined range. For example, an activation function may be used to perform normalization on the percentage value. For example, the normalized value may be expressed as a value between 0 and 1 or a value between 0% and 100%.

FIG. 9 is a diagram illustrating an artificial neural network model 900 according to one embodiment of the present disclosure. The artificial neural network model 900 is an example of the machine-learning model, and may be a statistical learning algorithm implemented based on the structure of a biological neural network in machine-learning technology and cognitive science, or may be a structure that executes the algorithm. According to some embodiments, the artificial neural network model 900 may be included in at least one of the first machine-learning model, the second machine-learning model, and the third machine-learning model as described above.

According to one embodiment, the artificial neural network model 900 may represent a machine-learning model having problem-solving capabilities by the nodes as artificial neurons constituting a network via combining of synapses like in a biological neural network repeatedly adjusting the weights of synapses so that the error between the correct output corresponding to a specific input and the inferred output corresponding to the specific input is reduced. For example, the artificial neural network model 900 may include any probability model, neural network model, etc. used in artificial intelligence learning methods such as machine-learning and deep learning.

At least one of the first machine-learning model, the second machine-learning model, and the third machine-learning model as described above may be implemented in a form of an artificial neural network model 900. According to one embodiment, the artificial neural network model 900 may be configured to output the technology feature data based on the public technology data. Furthermore, the artificial neural network model 900 may be configured to output the consumer feature data based on the technology consumer data. Furthermore, the artificial neural network model 900 may be configured to output the score indicating the success possibility of the technology trade between the public technology and the technology consumer, based on the consumer feature data and the technology feature data.

The artificial neural network model 900 may be implemented as a multilayer perceptron (MLP) composed of multiple layers of nodes and links therebetween. The artificial neural network model 900 according to this embodiment may be implemented using one of various artificial neural network model structures including MLP. The artificial neural network model 900 is composed of an input layer that receives input signals or data from an external source, an output layer that outputs output signals or data corresponding to the input data, and n hidden layers (n is a positive integer) located between the input layer and the output layer, and configured to receive the signals from the input layer, extract the features therefrom, and transmit the features to the output layer.

A plurality of input variables and a plurality of output variables corresponding to the plurality of input variables are respectively matched with the input layer and the output layer of the artificial neural network model 900. The model may be trained so that the correct output corresponding to a specific input may be extracted by adjusting the synapse values between the nodes included in the input layer, the hidden layer, and the output layer. When the artificial neural network model 900 is repeatedly trained based on the data included in the training data set, the synapse values or weights between the nodes of the artificial neural network model 900 are adjusted so as to be converged to an optimal value so that the error between the output variables calculated based on the input variables and the target output is reduced.

In one example, in the above-described embodiments, the first machine-learning model, the second machine-learning model, and the third machine-learning model are described as being implemented independently of each other. However, two or more of the first machine-learning model, the second machine-learning model, and the third machine-learning model may be integrated with each other.

Each of the above-described first machine-learning, the second machine-learning model, and the third machine-learning model may be trained based on a training data set. The training data set may include labeled data, and each of the first machine-learning, the second machine-learning model, and the third machine-learning model may be trained to output data that is approximate to the correct data (ground truth) included in the labeled data. For example, the third machine-learning model may be trained based on labeled data based on existing technology trade success cases.

According to some embodiments, the training data may include both data about the technology trade which has been successful and data about the technology trade which has not been successful. In general, the number of cases in which the technology trade is not successful is greater than the number of cases in which the technology trade is successful. Thus, when the training is performed using the training data including both data about the technology trade which has been successful and data about the technology trade which has not been successful, a bias may occur in the training result. Accordingly, in the training process, the number of cases in which the technology trade is not successful and the number of cases in which the technology trade is successful may be set to be substantially equal to each other. To this end, the data about the technology trade which has not been successful may not be entirely used, but only a portion of the data about the technology trade which has not been successful may be extracted and used. In this regard, the extraction scheme may be important. In the present embodiment, for example, the data may be extracted based on the business sector (the 10th industry code of the technology consumer data). In this regard, the extraction may be performed on the data about the technology trade which has not been successful such that a percentage of each business sector in the data about the technology trade which has not been successful is equal to a percentage of each business sector in the data about the technology trade which has been successful. Specifically, based on an analyzing result of the plurality of technology trade success data obtained from the technology trade-related DB (not shown in the drawings) based on the 10th industry code major classification (the alphabet and the preceding number 1 or 2 digits of the 10th industry code), it is identified that there may be many successful technology trade cases in a specific business sector, and there may be few successful technology trade cases in another specific business sector. In one example, in the 10th industry code, C27 medical, precision, optical equipment, and watch manufacturing business sector has 30% success probability of technology trade, while A01 agriculture business sector has 3% success probability of technology trade. Thus, in the C27 medical, precision, optical equipment, and watch manufacturing business sector has higher success probability of technology trade. Thus, the extraction may be performed on the data about the technology trade which has not been successful such that a percentage of each business sector in the data about the technology trade which has not been successful is equal to a percentage of each business sector in the data about the technology trade which has been successful (as in the previous example, the extraction may be performed on the data about the technology trade which has not been successful such that a percentage of the C27 medical, precision, optical equipment, and watch manufacturing business sector is 30%, and a percentage of the A01 agriculture is 3%), the bias in the training result may be reduced to achieve more accurate training.

FIG. 10 is a flowchart for illustrating a method for matching a public technology with a technology consumer according to an embodiment of the present disclosure.

Referring to FIG. 10, the service server may acquire data about the public technology in S210. For example, the service server may receive the first raw data from the user device and perform data profiling on the received first raw data to acquire the data about the public technology that may be applied to the first machine-learning model. In another example, the service server may receive the data about the public technology that may be directly applied to the first machine-learning model from the user device.

Subsequently, the service server may apply the acquired data about the public technology to the first machine-learning model to acquire the technology feature data about the public technology in S220. In this regard, the first machine-learning model may be a model configured and trained to output the technology feature data based on the data about the public technology.

Thereafter, the service server may match the public technology with at least one technology consumer based on the technology feature data and the plurality of consumer feature data stored in the feature database in S230.

According to one embodiment, the service server may apply the technology feature data and the plurality of consumer feature data to the third machine-learning model to acquire the score indicating the success possibility of the technology trade corresponding to each of the plurality of consumer feature data. In this regard, the third machine-learning model may be a model configured and trained to output the score indicating the success possibility of the technology trade between the technology feature data and the consumer feature data. Thereafter, the service server may extract one or more consumer feature data from the plurality of consumer feature data based on the acquired score, and determine at least one technology consumer matching the public technology based on the extracted one or more consumer feature data. For example, the service server may extract one or more consumer feature data corresponding to a score included within a predetermined rank from among scores corresponding to the plurality of consumer feature data. The server may determine that the technology consumer related to the extracted one or more consumer feature data matches the public technology.

In another example, the service server may extract one or more consumer feature data corresponding to a score greater than or equal to a predetermined threshold from among scores corresponding to the plurality of consumer feature data. The server may determine that the technology consumer related to the extracted one or more consumer feature data matches the public technology.

According to some embodiments, the service server may convert the acquired score into a normalized value within a predetermined range. Furthermore, the service server may transmit information about the at least one technology consumer which has matched with the public technology to the user device. In this regard, the information about the technology consumer may include the normalized value.

FIG. 11 is a diagram illustrating a procedure for calculating a score related to a technology trade success possibility by using the first machine-learning model and the third machine-learning model according to an embodiment of the present disclosure.

The first machine-learning model 410 as illustrated in FIG. 11 corresponds to the first machine-learning model 100 of FIG. 6. The third machine-learning model 420 illustrated in FIG. 11 may correspond to the third machine-learning model 300 of FIG. 8.

As illustrated in FIG. 11, public technology data 440 may be applied to the first machine-learning model 410, such that technology feature data 450 may be output from the first machine-learning model 410. Furthermore, the technology feature data 450 and consumer feature data 460 stored in the feature DB 430 may be applied to the third machine-learning model 420, such that a score 470 based on the consumer feature data 460 and the technology feature data 450 may be output therefrom. In this regard, the score 470 may be a numerical representation of the success possibility of the technology trade between the public technology corresponding to the technology feature data 450 and the technology consumer corresponding to the consumer feature data 460.

As described above, when the public technology data 440 has been acquired, the first machine-learning model 410 and the third machine-learning model 420 are used to match at least one technology consumer with the public technology. Furthermore, since the consumer feature data 460 pre-stored in the feature DB 430 is input to the third machine-learning model 420, computing resources required to produce the consumer feature data 460 may be saved and the computation time may be shortened. As a result, the third machine-learning model 420 may be made lighter.

FIG. 12 is a flowchart for illustrating a method for matching a public technology with a technology consumer according to another embodiment of the present disclosure.

Referring to FIG. 12, the service server may acquire data about the technology consumer in S310. For example, the service server may receive the second raw data from the user device, and perform data profiling on the received second raw data to acquire the data about the technology consumer that is applied to the second machine-learning model. In another example, the service server may receive the data about the technology consumer that may be directly applied to the second machine-learning model from the user device.

Subsequently, the service server may apply the acquired technology consumer-related data to the second machine-learning model to acquire the consumer feature data about the technology consumer in S320. In this regard, the second machine-learning model may be a model that is configured and trained to output the consumer feature data based on the data about the technology consumer.

Thereafter, the service server may match the technology consumer with one or more public technologies based on the consumer feature data and the plurality of technology feature data stored in the feature database in S330.

According to one embodiment, the service server may apply the consumer feature data and the plurality of technology feature data to the third machine-learning model to acquire the score indicating the success possibility of the technology trade corresponding to each of the plurality of technology feature data. In this regard, the third machine-learning model may be configured and trained to output the score indicating the success possibility of the technology trade between the consumer feature data and the technology feature data. Thereafter, the service server may extract one or more technology feature data from the plurality of technology feature data based on the acquired score. The server may determine one or more public technologies matching the technology consumer based on the extracted one or more technology feature data. For example, the service server may extract one or more technology feature data corresponding to a score included in a predetermined rank from the scores corresponding to the plurality of technology feature data. The server may determine that the public technology related to the extracted one or more technology feature data matches the technology consumer. In another example, the service server may extract one or more technology feature data corresponding to a score greater than or equal to a predetermined threshold value from among scores corresponding to the plurality of technology feature data. The server may determine that a public technology related to the extracted one or more technology feature data matches the technology consumer.

According to some embodiments, the service server may convert the acquired score into a normalized value within a predetermined range. Furthermore, the service server may transmit information about the one or more public technologies which has matched with the technology consumer to the user device. In this regard, the information about the public technology may include the normalized value.

FIG. 13 is a diagram illustrating a procedure in which a second machine-learning model and a third machine-learning model are used to produce a score related to a technology trade success possibility according to an embodiment of the present disclosure.

The second machine-learning model 510 illustrated in FIG. 13 may correspond to the second machine-learning model 200 of FIG. 7, and the third machine-learning model 520 illustrated in FIG. 13 may correspond to the third machine-learning model 300 of FIG. 8.

As illustrated in FIG. 13, technology consumer data 540 may be applied to the second machine-learning model 510, such that consumer feature data 550 may be output from the second machine-learning model 510. Furthermore, consumer feature data 550 and technology feature data 560 stored in a feature DB 530 may be applied to the third machine-learning model 520, such that a score 570 based on the consumer feature data 550 and the technology feature data 560 may be output therefrom. In this regard, the score 570 may be a numerical representation of the success possibility of the technology trade between a technology consumer related to the consumer feature data 550 and a public technology related to the technology feature data 560.

As described above, when the technology consumer data 540 has been acquired, the second machine-learning model 510 and the third machine-learning model 520 may be used to match at least one public technology with the technology consumer.

FIG. 14 is a hardware configuration view of an exemplary computing system 1000 according to some embodiments of the present disclosure. The computing system 1000 may include at least one processor 1100, a bus 1600, a communication interface 1200, a memory 1400, which loads a computer program 1500 to be executed by the processor 1100, and a storage 1300, which stores the computer program 1500.

The computing system 1000 of FIG. 14 may present a hardware structure of a computing system that constitutes the matching system described with reference to FIG. 1.

The processor 1100 may control the overall operations of the components of the computing system 100. The processor 1100 may perform operations related to at least one application or program to execute operations/methods according to various embodiments of the present disclosure. The memory 1400 may store various data, commands, and/or information. The memory 1400 may load the computer program 1500 from the storage 1300 to execute the operations/methods according to various embodiments of the present disclosure. The storage 1300 may non-transitorily store at least one computer program 1500.

The computer program 1500 may include one or more instructions that enable the processor 1100 to perform the operations/methods according to various embodiments of the present disclosure when loaded into the memory 1400. In other words, by executing the loaded instructions, the processor 1100 may perform the operations/methods according to various embodiments of the present disclosure.

According to one embodiment, the computer program 1500 may include instructions for acquiring data about the public technology, applying the acquired data to the first machine-learning model to acquire technology feature data about the public technology, and matching the public technology with at least one technology consumer based on the technology feature data and a plurality of consumer feature data stored in a database.

Furthermore, the computer program 1500 may include instructions for acquiring data about a technology consumer, applying the acquired data to a second machine-learning model to acquire the consumer feature data about the technology consumer, and matching the technology consumer with one or more public technologies based on the consumer feature data and a plurality of technology feature data stored in a database.

Furthermore, the computer program 1500 may include instructions for acquiring data about the public technology, applying the data about the public technology to a first machine-learning model to acquire technology feature data about the public technology, associating the technology feature data with a public technology identifier and storing the association in the database.

In some embodiments, the computing system 1000 as described with reference to FIG. 14 may be configured using one or more physical servers included in a server farm based on cloud technology such as virtual machines. In this case, at least some of the components as illustrated in FIG. 14, such as the processor 1100, the memory 1400, and the storage 1300 may be virtual hardware, and the communication interface 1200 may also be embodied as a virtualized networking element such as a virtual switch.

So far, a variety of embodiments of the present disclosure and the effects according to embodiments thereof have been mentioned with reference to FIGS. 1 to 14. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device. Although operations are shown in a specific order in the drawings, it should not be understood that desired results can be obtained when the operations must be performed in the specific order or sequential order or when all of the operations must be performed. In certain situations, multitasking and parallel processing may be advantageous.

Although some embodiments of the present disclosure have been described above with reference to the accompanying drawings, the present disclosure may not be limited to some embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that some embodiments as described above are not restrictive but illustrative in all respects.

What is claimed is:

1. A method for matching a public technology with a technology consumer, the method being performed by a computing system, the method comprising:
acquiring data about the public technology;
applying the acquired data to a first machine-learning model to acquire technology feature data about the public technology, wherein the first machine-learning model is configured to output the technology feature data based on the data about the public technology; and
matching the public technology with at least one technology consumer, based on the technology feature data and a plurality of consumer feature data stored in a database.

2. The method of claim 1, further comprising:
before the acquiring of the data about the public technology,
acquiring a plurality of data respectively about a plurality of technology consumers;
applying the plurality of data respectively about the plurality of technology consumers to a second machine-learning model to acquire a plurality of consumer feature data respectively about the plurality of technology consumers, wherein the second machine-learning model is configured to output the consumer feature data based on the data about the technology consumer; and
storing the acquired plurality of consumer feature data in the database.

3. The method of claim 1, wherein the matching of the public technology with the at least one technology consumer includes:
applying the technology feature data and the plurality of consumer feature data to a third machine-learning model to acquire a score indicating a technology trade success possibility corresponding to each of the plurality of consumer feature data, wherein the third machine-learning model is configured to output the score indicating the success possibility of the technology trade between the technology feature data and the consumer feature data;
extracting one or more consumer feature data from the plurality of consumer feature data based on the acquired score; and
determining at least one technology consumer matching the public technology, based on the extracted one or more consumer feature data.

4. The method of claim 3, wherein the extracting of the one or more consumer feature data from the plurality of consumer feature data includes:
extracting one or more consumer feature data corresponding to a score included in a predetermined rank among scores corresponding to the plurality of consumer feature data.

5. The method of claim 3, wherein the extracting of the one or more consumer feature data from the plurality of consumer feature data includes:
extracting one or more consumer feature data corresponding to a score higher than or equal to a predetermined threshold value among scores corresponding to the plurality of consumer feature data.

6. The method of claim 3, wherein the matching of the public technology with the at least one technology consumer includes: converting the acquired score into a normalized value within a predetermined range,
wherein the matching method further comprises, after the matching of the public technology with the at least one technology consumer, transmitting information about the at least one technology consumer to a user device,
wherein the information about the technology consumer includes the normalized value.

7. A method for matching a public technology with a technology consumer, the method being performed by a computing system, the method comprising:
acquiring data about the technology consumer;
applying the acquired data to a first machine-learning model to acquire consumer feature data about the technology consumer, wherein the first machine-learning model is configured to output the consumer feature data based on the data about the technology consumer; and
matching the technology consumer with one or more public technologies, based on the consumer feature data and a plurality of technology feature data stored in a database.

8. The method of claim 7, further comprising:
before the acquiring of the data about the technology consumer,
acquiring a plurality of data respectively about a plurality of public technologies;
applying the plurality of data respectively about the plurality of public technologies to a second machine-learning model to acquire a plurality of technology feature data respectively about the plurality of public technologies, wherein the second machine-learning model is configured to output the technology feature data based on the data about the public technology; and
storing the acquired plurality of technology feature data in the database.

9. The method of claim 7, wherein the matching of the technology consumer with the one or more public technologies includes:
applying the consumer feature data and the plurality of technology feature data to a third machine-learning model to acquire a score indicating a trade success possibility corresponding to each of the plurality of technology feature data, wherein the third machine-learning model is configured to output a score indicating a technology trade success possibility between the consumer feature data and the technology feature data;
extracting one or more technology feature data from the plurality of technology feature data, based on the acquired score; and
determining one or more public technologies matching the technology consumer, based on the extracted one or more technology feature data.

10. The method of claim 9, wherein the extracting of the one or more technology feature data from the plurality of technology feature data includes extracting the one or more technology feature data corresponding to a score included in a predetermined rank among the scores corresponding to the plurality of technology feature data.

11. The method of claim 9, wherein the extracting of the one or more technology feature data from the plurality of technology feature data includes extracting the one or more technology feature data corresponding to a score higher than or equal to a predetermined threshold value among the scores corresponding to the plurality of technology feature data.

12. The method of claim 9, wherein the matching of the technology consumer with the one or more public technologies includes converting the acquired score into a normalized value within a predetermined range,
wherein the matching method further comprises:
after the matching of the technology consumer with the one or more public technologies,
transmitting information about the one or more public technologies matching with the technology consumer to the user device,
wherein the information about the public technology includes the normalized value.

13. A method for constructing a database for matching a public technology with a technology consumer, the method being performed by a computing system, the method comprising:
acquiring data about the public technology;
applying the data about the public technology to a first machine-learning model to acquire technology feature data about the public technology, wherein the first machine-learning model is configured to output the technology feature data based on the data about the public technology; and
associating the technology feature data with a public technology identifier, and storing the association in a database.

14. The method of claim 13, wherein the first machine-learning model includes a preprocessing unit,
wherein the data about the public technology includes at least one text,
wherein the preprocessing unit is configured to:
extract at least one keyword from the at least one text;
reduce a first magnitude vector based on the extracted at least one keyword into a second magnitude vector, wherein the second magnitude is smaller than the first magnitude; and
output the second magnitude vector.

15. The method of claim 13, further comprising:
acquiring data about the technology consumer;
applying the data about the technology consumer to a second machine-learning model to acquire consumer feature data about the technology consumer, wherein the second machine-learning model is configured to output the consumer feature data based on the data about the technology consumer; and
associating the consumer feature data with a technology consumer identifier and storing the association in the database.

16. The method of claim 15, wherein the second machine-learning model includes a preprocessing unit,
wherein the data about the public technology includes at least one text,
wherein the preprocessing unit is configured to:
extract at least one keyword from the at least one text; and
reduce a third magnitude vector based on the extracted at least one keyword into a fourth magnitude vector, wherein the fourth magnitude smaller than the third magnitude; and
output the fourth magnitude vector.
